(19) United States
(12) Patent Application Publication
(10) Pub. No.: US 2006/0036661 A1
(43) Pub. Date: Feb. 16, 2006

(54) Database information processing system

(76) Inventor: Edward J. Brennan JR., King of Prussia, PA (US)

Correspondence Address: Siemens Corporation;Intellectual Property Department, 170 Wood Avenue South, Iselin, NJ, 08830, US

(21) Appl. No.: 11/203,784

(22) Filed: Aug. 15, 2005

Related U.S. Application Data
(60) Provisional application No. 60/601,543, filed on Aug. 13, 2004.

(51) Int. Cl. G06F 17/30

(52) U.S. Cl. 707/204

(57) ABSTRACT

A method updates database information in a database information processing system. The system converts existing user ancillary information, supporting querying of an existing database of a user, to a first format supporting interchange of structured data. The system receives updated database ancillary information supporting querying of the existing database in the first format. The system automatically compares and merges the existing user ancillary information in the first format and the received updated database ancillary information in the first format to create composite database ancillary information, by performing the following two processes. First, the system identifies differences between the updated and existing ancillary information. Next, the system applies predetermined prioritized data replacement and substitution rules in merging the updated and existing ancillary information.

### CROSS-REFERENCE TO RELATED APPLICATIONS

The present application is a non-provisional application of provisional application having Ser. No. 60/601,543 filed by Edward J. Brennan, Jr. on Aug. 13, 2004.

### FIELD OF THE INVENTION

The present invention generally relates to computer systems. More particularly, the present invention relates to a database information processing system.

### BACKGROUND OF THE INVENTION

Online analytical processing (“OLAP”) is a database information processing approach to quickly provide answers to complex analytical queries, which are typically applied to business entities. A data warehouse software vendor typically provides an OLAP database “starter set” which gives customers a basis for starting OLAP data analysis. Since the “starter set” typically does not meet all of the customer's data analysis needs, the customer adapts and extends the OLAP database to meet the customer's particular data analysis needs.

The software vendor encourages and supports the customer's customizations to increase the capabilities of the software. However, the customizations present challenges to the software vendor when releasing the next version of the same software. For example, while the customer is adapting and extending the existing installed “starter set,” the software vendor is adapting and extending the “starter set” for the next version of the same software. Therefore, the software vendor's new release of the software needs to preserve the customer's customizations of the present software while including the software vendor's changes to the new release of the software.

Software vendors typically provide a software upgrade process for the new release of the software by preparing a collection of manual instructions to be performed by the customer within the OLAP's user interface. However, documenting the instructions by the software vendor is time consuming and can result in missed or imprecise instructions. Further, manually implementing the instructions by the customer is both time consuming and error-prone. Accordingly, there is a need for a database information processing system that overcomes these and other disadvantages of the prior systems.

### SUMMARY OF THE INVENTION

A method updates database information in a database information processing system. The system converts existing user ancillary information, supporting querying of an existing database of a user, to a first format supporting interchange of structured data. The system receives updated database ancillary information supporting querying of the existing database in the first format. The system automatically compares and merges the existing user ancillary information in the first format and the received updated database ancillary information in the first format to create composite database ancillary information, by performing the following two processes. First, the system identifies differences between the updated and existing ancillary information. Next, the system applies predetermined prioritized data replacement and substitution rules in merging the updated and existing ancillary information.

### BRIEF DESCRIPTION OF THE DRAWINGS

FIG. 1 illustrates a database information processing system.

FIG. 2 illustrates a general method for updating database information for the system, as shown in FIG. 1.

FIG. 3 illustrates a particular method for updating database information for the system, as shown in FIG. 1.

FIG. 4 illustrates a flow diagram for updating database information, corresponding to the particular method, as shown in FIG. 3.

FIG. 5 illustrates a method of comparing and merging information for a corresponding step, as shown in the FIG. 3.

FIG. 6 illustrates an example of updating database information, according to FIGS. 1-5.

### DETAILED DESCRIPTION OF THE PREFERRED EMBODIMENT

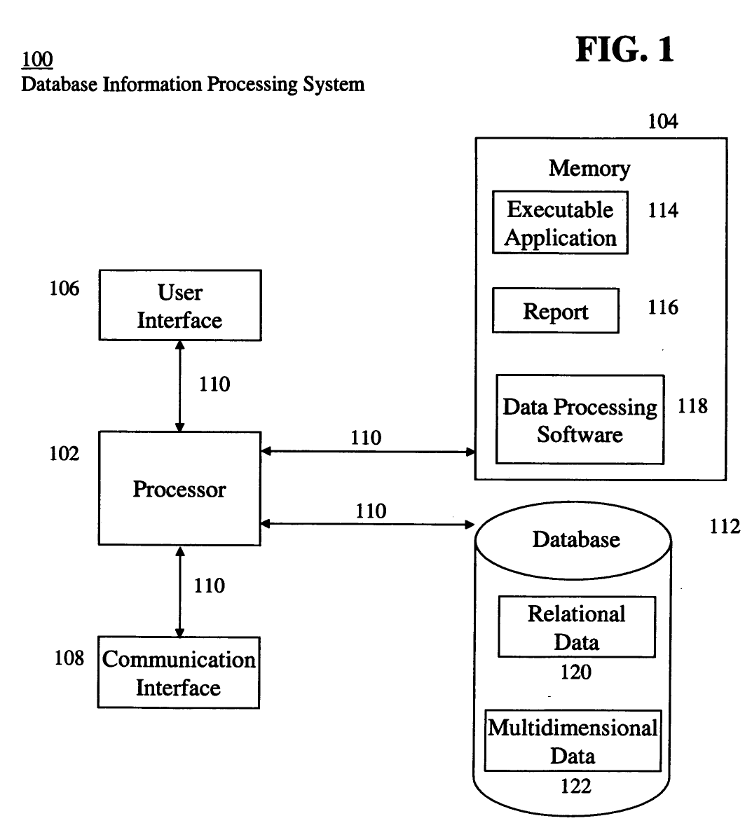

FIG. 1 illustrates a database information processing system 100. The system 100 includes a processor 102, a memory 104, a user interface 106, a communication interface 108, a communication path 110, and a database 112. The memory 104 stores an executable application 114, a report 116, and data processing software 118. The database 112 stores relational data 120 and multidimensional data 122. The processor 102 is electrically coupled to each of the memory 104, the user interface 106, the communication interface 108, and the database 112 over the communication path 110.

The system 100 may be employed by any type of enterprise, organization, or department, such as, for example, providers of healthcare products and/or services responsible for servicing the health and/or welfare of people in its care. For example, the system 100 represents a hospital information system. A healthcare provider provides services directed to the mental, emotional, or physical well being of a patient. Examples of healthcare providers include a hospital, a nursing home, an assisted living care arrangement, a home health care arrangement, a hospice arrangement, a critical care arrangement, a health care clinic, a physical therapy clinic, a chiropractic clinic, a medical supplier, a pharmacy, and a dental office. When servicing a person in its care, a healthcare provider diagnoses a condition or disease, and recommends a course of treatment to cure the condition, if such treatment exists, or provides preventative healthcare services. Examples of the people being serviced by a healthcare provider include a patient, a resident, a client, and an individual.

The system 100 may be fixed and/or mobile (i.e., portable), and may be implemented in a variety of forms including, but not limited to, one or more of the following: a personal computer (PC), a desktop computer, a laptop computer, a workstation, a minicomputer, a mainframe, a supercomputer, a network-based device, a personal digital assistant (PDA), a smart card, a cellular telephone, a pager, and a wristwatch. The system 100 and/or elements contained therein also may be implemented in a centralized or decentralized configuration.

The communication path 110 (otherwise called network, bus, link, connection, channel, etc.) represents any type of protocol or data format including, but not limited to, one or more of the following: an Internet Protocol (IP), a Transmission Control Protocol Internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, a Campus Area Network (CAN) protocol, a Metropolitan Area Network (MAN) protocol, a Home Area Network (HAN) protocol, an Institute Of Electrical And Electronic Engineers (IEEE) bus compatible protocol, a Digital and Imaging Communications (DICOM) protocol, and a Health Level Seven (HL7) protocol.

The system 100 and/or elements contained therein may be implemented in hardware, software, or a combination of both, and may include one or more processors.

The processor 102 is a device and/or set of machine-readable instructions for performing task. The processor 102 includes any combination of hardware, firmware, and/or software. The processor 102 acts upon stored and/or received information by computing, manipulating, analyzing, modifying, converting, or transmitting information for use by an executable application or procedure or an information device, and/or by routing the information to an output device. For example, the processor 102 may use or include the capabilities of a controller or microprocessor.

The user interface 106 permits bi-directional exchange of data with the processor 102. The user interface 106 includes a data input device (not shown) and a data output device (not shown).

The data input device provides data to the processor 102 in response to receiving input data either manually from a user or automatically from an electronic device, such as a computer. For manual input, the data input device is a keyboard and a mouse, but also may be a touch screen, or a microphone with a voice recognition application, for example. For automatic input, the data input device is a data modem.

The data output device provides data from the processor 102 for use by a user or an electronic device, such as a computer. For output to a user, the data output device is a display that generates display images in response to receiving the display signals from the processor, but also may be a speaker or a printer, for example. For electronic output to an electronic device, the data output device is a data modem.

The communication interface 108 provides a boundary across which the system 100 and one or more other systems meet and act on or communicate with each other. For example, the communication interface 108 facilitates a bi-directional exchange of data between the processor 102 and a processor associated with another system, device, etc.

The memory 104 represents one or more numbers and/or types of electronic data storage devices, such as, for example, read only memory (ROM), random access memory (RAM), cache, and/or virtual memory.

The executable application 114 in the memory 104 comprises code or machine readable instruction for implementing predetermined functions including, for example, those of an operating system, a software application program, a healthcare information system, or other information processing system, for example, in response user command or input. An executable procedure is a segment of code (i.e., machine readable instruction), sub-routine, or other distinct section of code or portion of an executable application for performing one or more particular processes, and may include performing operations on received input parameters (or in response to received input parameters) and providing resulting output parameters. A calling procedure is a procedure for enabling execution of another procedure in response to a received command or instruction. An object comprises a grouping of data and/or executable instructions or an executable procedure.

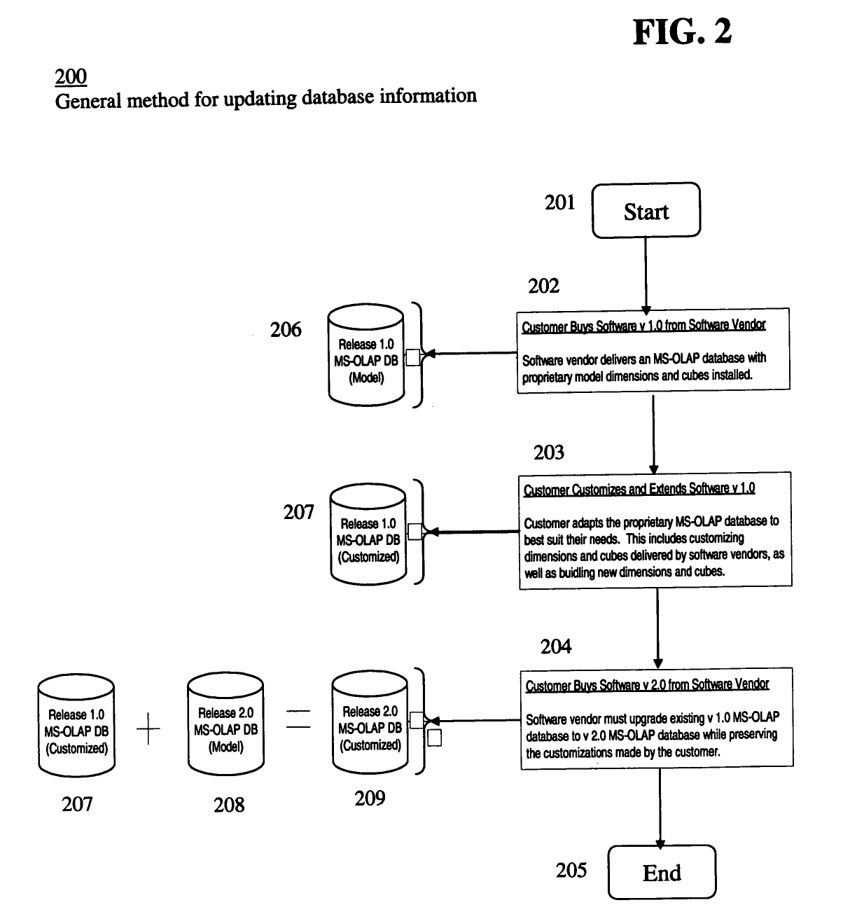

The report 116 in the memory 104 provides a record of information related to performance of the system 100, such as updating information in the database 112, as shown, for example, in FIGS. 2 to 5. Examples of recorded information include: activities, steps, information, data, objects, text, numbers, software versions, inputs, outputs, results, calculations, substitutions, additions, deletions, etc.

The database 112 is a collection of information organized and related in such a way that the data processing software 118 can quickly select and act on desired pieces of data. The database 112 may be called a data warehouse and/or a data mart. A data warehouse typically stores a large set of data, and typically covers an entire enterprise. A data mart stores a small set of data, and typically covers a single function in an organization. The database 112 includes relational data 120 and multidimensional data 122 (otherwise called an “OLAP database”). A record is a compilation of data 120 and/or 122 including one or more of the following: scheduling data, task related data, workflow data, imaging data and images associated information, for example, in electronic form.

The data processing software 118 processes the data 120 and 122 that is stored in the database 112. The system 100 employs online analytical processing, otherwise called OLAP, using the data processing software 118. OLAP is also known as multidimensional data analysis. OLAP is an approach to quickly provide answers to complex analytical queries. OLAP is part of broader business intelligence category, which includes reporting and data mining. Typical applications of OLAP are in business reporting for sales, marketing, management reporting, business performance management, budgeting, forecasting, financial reporting, etc.

Characteristics of OLAP include: operating with a multidimensional model of data (as opposed to a relational model), allowing complex analytical and ad-hoc queries, and performing very fast query searches (typically, less than 5 seconds). Typically, OLAP takes a snapshot of relational data 120 in a relational database 112, and restructures the snapshot of the relational data 120 into multidimensional data 122. Queries are run against the multidimensional data 122.

Three general types of OLAP include: Multidimensional OLAP (MOLAP), Relational OLAP (ROLAP), and Hybrid OLAP (HOLAP). Further, a particular type of OLAP adapted by Microsoft® is called MS-OLAP.

MOLAP is the classic form of OLAP, and is sometimes referred to as just OLAP. MOLAP uses a summary database, has a specific dimensional database engine, and creates a required schema as a dimensional set of both the data and aggregations. A schema is a conceptual model of the structure of a database that defines the data contents and relationships, such as, for example, a set of objects (tables, views, indexes, etc) belonging to an account. MOLAP works better with smaller sets of data, performs searches faster than ROLAP and HOLAP, and returns answers but does create enormous amounts of data.

ROLAP works directly with relational databases. The base data and the dimension tables are stored as relational tables and new tables are created to hold the aggregation information. Dimension tables contain attributes that describe fact records in the fact table. Some of these attributes provide descriptive information; others are used to specify how fact table data should be summarized to provide useful information to the analyst. Dimension tables contain hierarchies of attributes that aid in summarization. ROLAP is more scalable and uses the least space, but performs pre-processing and query performance slower than MOLAP and HOLAP.

HOLAP uses relational tables to hold base data and uses multi-dimensional tables to hold the speculative aggregations (i.e., aggregations not yet performed, but available). HOLAP is between MOLAP and ROLAP in various areas, and can pre-process quickly and scale well.

The data processing software 118 enables users to analyze different dimensions of the multidimensional data 122 to create various views and representations of the multidimensional data 122. The data processing software 118 provides fast, consistent, interactive access to shared, multidimensional data 122. The software 118 provides on-line retrieval and analysis of multidimensional data 122 to reveal business trends and statistics not directly visible in the relational data 120 directly retrieved from the database 112. Typically, the data processing software 118 provides multidimensional, summarized views of business data, and is used for reporting, analysis, modeling and planning for optimizing a business.

The multidimensional data 122 (i.e., OLAP data) is organized into multidimensional cubes by transforming the relational data 120 from relational tables into the multidimensional data 122, as is well known to those skilled in the art. The structure of multidimensional data 122 in multidimensional cubes gives better performance for OLAP queries than the relational data 120 organized in relational tables.

A basic unit of a multidimensional cube is called a measure. Measures are the units of data that are being analyzed. For example, a corporation that operates hardware stores wants to analyze revenue and discounts for the different products it sells. The measures are the number of units sold, revenue, and the sum of any discounts. The measures are organized along dimensions. In this example, a three dimensional cube could have these dimensions: time, store, and products. These dimensions may be thought of as forming the logical x-axis, y-axis, and z-axis of a three-dimensional, virtual cube, resulting in a multidimensional cube.

Each dimension is divided into units called members. The members of a dimension are typically organized into a hierarchy. Similar members are grouped together as a level of the hierarchy. For example, the top hierarchy level of a time dimension can be years, with months at the next level, then weeks, days, and finally hours at the bottom level of the hierarchy. At each intersection of the three dimensions, the values for the measures that match those three dimension values are recorded. The specific dimensions and measures defined for the cubes in any particular OLAP system depend on the kinds of analysis important to a particular enterprise.

For example, suppose that the hour starting at 1:00 P.M. Saturday, Feb. 19, 2000 is a time dimension member, store #2 of Austin, Tex. is a store dimension member, and Clean-Up Mops are a product dimension member. For these three dimensions, the software records that ten mops were sold for revenues of $90.00 and an average discount of $1.00.

FIG. 2 illustrates a general method for updating database information 200 for the system 100, as shown in FIG. 1.

At step 201, the method 200 starts.

At step 202, a customer (i.e., user) of the system 100 buys data processing software 118 (e.g., version 1.0), including pre-installed multidimensional data 122, from a software vendor. The multidimensional data 122 includes proprietary model dimensions and cubes. The customer installs the data processing software 118 on the system 100. At step 202, the multidimensional data 122 together is considered “model,” 206 because it is a clean, original version from the software vendor, without modification by the customer.

At step 203, the customer of the system 100 customizes and extends the data processing software 118 (e.g., version 1.0), including pre-installed multidimensional data 122. The customer adapts the proprietary multidimensional data 122 to best suit their particular needs. These needs include customizing dimensions and cubes delivered by the software vendor, as well as building and installing new dimensions and cubes. At step 203, the multidimensional data 122 is considered “customized” or “operational” 207 because the customer has modified or added to the software vendor's version.

At step 204, the customer of the system 100 buys a new version of the data processing software 118 (e.g., version 2.0) from the software vendor. The software vendor needs to upgrade the existing, version 1.0, data processing software 118, including the multidimensional data 122, with the new, version 2.0, data processing software 118, including the multidimensional data 122, while preserving the customizations made by the customer to the version 1.0, data processing software 118, including the multidimensional data 122. At step 204, the multidimensional data 122 is also considered “customized,” 209 because the customer's customized 207, version 1.0 multidimensional data 122 is combined with the software vendor's new 208, version 2.0 multidimensional data 122.

At step 205, the method 200 ends.

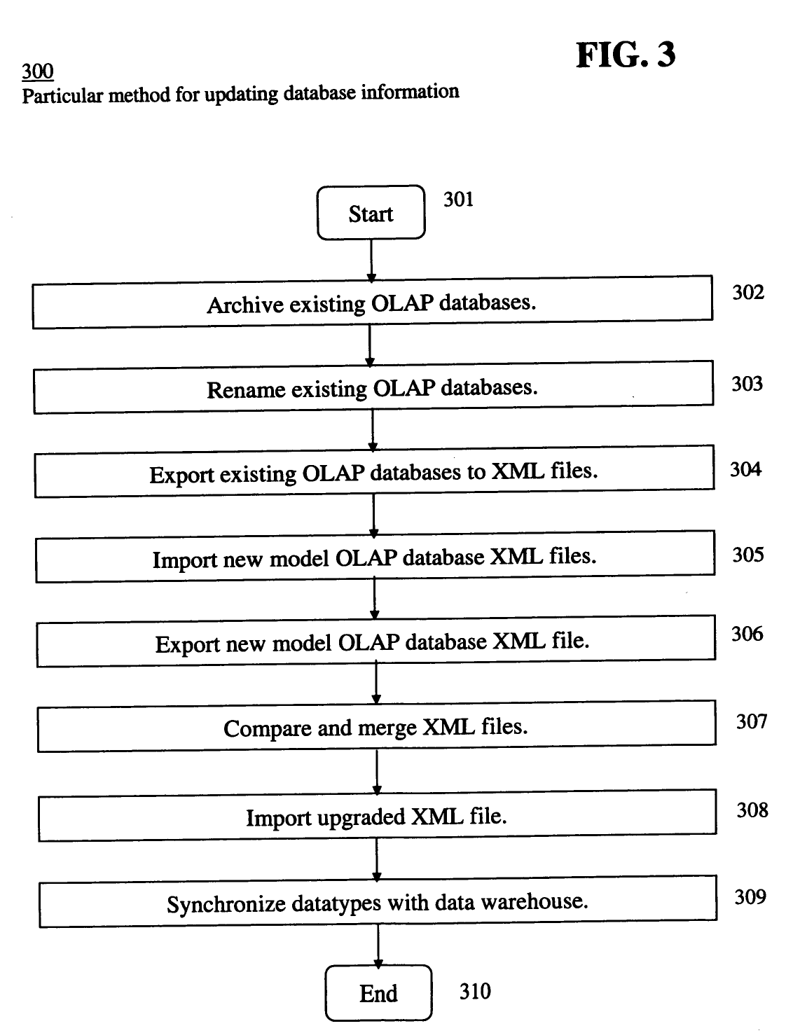

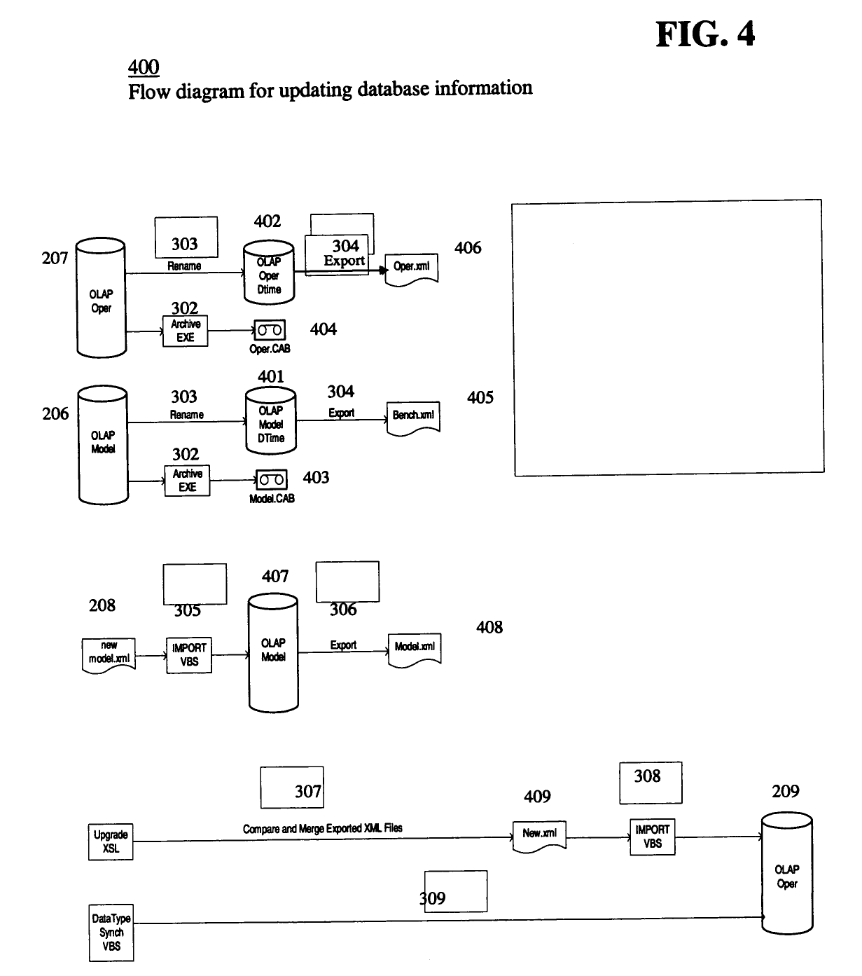

Next, FIGS. 3 and 4 are described together. FIG. 3 illustrates a particular method for updating database information 300 for the system 100, as shown in FIG. 1. FIG. 4 illustrates a flow diagram for updating database information 400, corresponding to the particular method 300, as shown in FIG. 3. The steps described in FIG. 3 are also shown in FIG. 4. The database descriptions in FIG. 2 are also shown in FIG. 4.

At step 301, the method 300 starts.

At step 302, the system 100 archives (i.e., stores) existing OLAP databases, including both the model 206 and operational 207 databases, to form Model.CAB 403 and Oper.CAB 404 stored databases, respectively (i.e., collectively referred to as existing user ancillary information supporting querying of an existing database of a user). The system 100 performs the archive process using an executable process (called “EXE” in FIG. 4) in the data processing software 118. Step 302 is a precautionary task to ensure that the existing OLAP databases are preserved and can be restored at a desired time for a desired reason that may arise.

At step 303, the system 100 renames existing OLAP databases, including both the model 206 and operational 207 databases (i.e., the existing user ancillary information). The system 100 performs the renaming function using the OLAP dynamic shared object (DSO) application programming interface (API), for example, as is well known to those skilled in the art. Renaming the existing OLAP databases to a date-stamped name (called “DTime” in FIG. 4) frees up the existing names for the delivery of upgraded OLAP databases using the original names. Further, renaming preserves a copy of the existing OLAP databases for comparison purposes with the upgraded equivalent OLAP databases. The system 100 renames model 206 and operational 207 databases to be model date-stamped 401 and operational date-stamped 402 databases.

At step 304, the system 100 exports or converts the existing, renamed OLAP databases (e.g., model date-stamped 401 and operational date-stamped 402) to extended markup language (XML) files (e.g., named Bench.xml 405 and Oper.xml 406, respectively). The existing, renamed OLAP databases 401 and 402 represents existing user ancillary information 401 and 402 supporting querying of an existing database of a user to a first format, such as XML, for example, supporting interchange of structured data. The user ancillary information 401 and 402 supporting querying of an existing database is OLAP compatible information.

As an alternative to the XML compatible data format, standard generalized markup language (SGML) or hypertext markup language (HTML) compatible data formats may also be used. The system 100 performs the export process through a component (COM) object, for example.

Exporting both of the existing, renamed OLAP databases, now renamed with a date stamp, to the XML files provides two XML files. The first file, Bench.xml 405, referred to as a “benchmark” file, contains the contents of the customer's existing model OLAP database. The first file contains a pristine version of the software vendor's previous release of the OLAP database 206.

The second file, Oper.xml 406, referred to as an “operational” file, contains the contents of the customer's existing customized, operational OLAP database 207. The second file contains the software vendor's previous release of the model OLAP database 206, customer adaptations to the model OLAP database 206, and customer additions to the model OLAP database 206 to form the customized, operational OLAP database 207.

At step 305, the system 100 imports or receives new model OLAP database 208 to provide a new model OLAP database 407. The system 100 performs the import process using a COM object, for example. The new model OLAP database 208 represents the software vendor's newest software release, including adaptations and additions made by the software vendor. The new model OLAP database 208 also represents updated database ancillary information supporting querying of the existing database in the first format such as XML, for example.

At step 306, the system 100 exports or converts the new model OLAP database 208. The system 100 performs the export process through a COM object, for example. Exporting the new, model OLAP database 208 to OLAP XML files provides an OLAP XML file 408 (e.g., named “MODEL.xml”). The MODEL.xml file 408 contains the contents of the customer's new model OLAP database. The MODEL.xml file 408 contains the software vendor's new release of the OLAP database (i.e., version 2.0). After step 306, the system 100 has created XML files: Oper.xml 406, Bench.xml 405, and Model.xml 408. The Oper.xml file 406 represents the customer's customized, operational database 207. The Bench.xml file 405 represents the first model software release (e.g., version 1.0) 206. The Model.xml 408 represents the second model software release (e.g., version 2.0) 208.

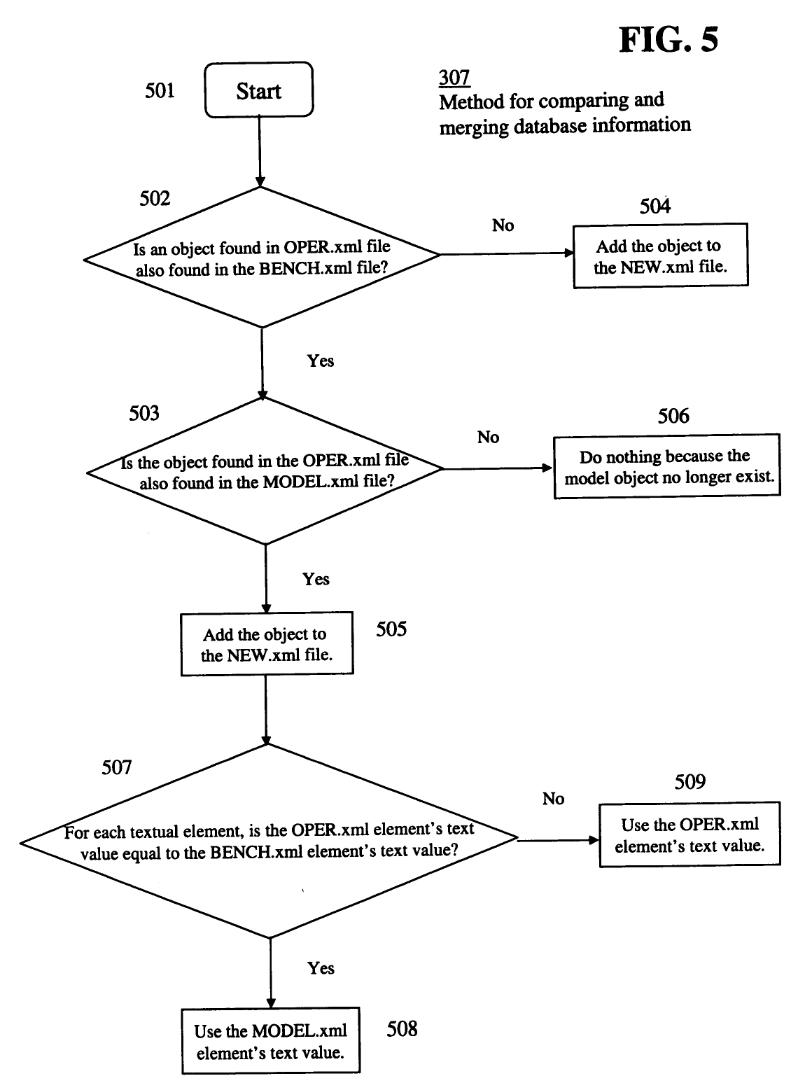

At step 307, the system 100 automatically compares and merges the three generated OLAP XML files (e.g., Bench.xml 405, Oper.xml 406, and Model.xml 408) to produce a new, upgraded OLAP XML file (e.g., named “New.xml”) 409. FIG. 5 describes further details about the compare and merge process in step 307. Step 307 represents automatically comparing and merging the existing user ancillary information 405 and 406 in the first format (e.g., XML), and the received updated database ancillary information 408 in the first format (e.g., XML) to create composite database ancillary information 409.

At step 308, the system 100 imports or updates the new, upgraded OLAP XML file 409, named NEW.xml. The system 100 performs the import process through a COM object, for example. Importing the NEW.xml file 409 provides a new, operational OLAP database 209 that is upgraded to the software vendor's latest release (e.g., version 2.0) and has preserved the customer's adaptations and additions. In step 308, the system updates the composite database ancillary information 409 to include data type determination information compatible with user information stored in the database 112.

At step 309, the system 100 synchronizes data types with the new, operational OLAP database 209. The database 112 also stores data type and length of physical dimensional model tables. The system 100 performs step 309 because upgrading these tables may have resulted in adjustments to the data type and length of these tables. The system 100 synchronizes the data types and lengths between the two disparate systems for the OLAP database objects and these tables to remain synchronized.

At step 310, the method 300 ends.

FIG. 5 illustrates a particular method of comparing and merging information for corresponding step 307, as shown in the FIG. 3. To successfully upgrade a customer's existing OLAP database, the system 100 identifies and accounts for the software vendor's changed and new OLAP database objects delivered in model software releases 206 and 208, respectively. The system 100 also identifies and accounts for the customer's adapted and added OLAP database objects found in an existing operational software release 207. The system 100 may perform the method of step 307 using a MS-OLAP DSO API software program, for example.

FIG. 5 represents a method 307 for creating the composite database ancillary information 409 by: a) identifying differences 502, 503, and 507 between the updated 408 and existing 405 and 406 ancillary information, and b) applying predetermined prioritized data replacement and substitution rules 504, 505, 506, 508, and 509 in merging the updated 408 and existing ancillary information 405 and 406.

At step 501, the method of step 307 starts.

At step 502, the system 100 determines if an object found in the Oper.xml file 406 is also found in the Bench.xml file 405. The system 100 compares the OPER.xml file 406 to the BENCH.xml file 405 to identify objects adapted or added by the customer. If the determination at step 502 is positive, then the process continues to step 503. Otherwise, if the determination at step 502 is negative, then the process continues to step 504.

At step 503, the system 100 determines if an object found in the Oper.xml file 406 is also found in the Model.xml file 408. If the determination at step 503 is positive, then the process continues to step 505. Otherwise, if the determination at step 503 is negative, then the process continues to step 506.

At step 504, the system 100 adds the object, found in the Oper.xml file 406 to the New.xml file 409. Step 504 represents an object that the customer adapted or added to the first model software release 206 because the object was not found in the first model software release 206.

At step 504, the predetermined prioritized data replacement and substitution rules substitute data by: adding, user generated modifications of the existing user ancillary information 405, to the composite database ancillary information 408, and adding, user generated additions to the existing user ancillary information 405, to the composite database ancillary information 408.

At step 505, the system 100 adds the object, found in the Model.xml file 408 to the New.xml file 505. Step 505 represents an object that is in both the first model 206 and second model 208 software releases, and was not added by the customer.

At step 505, the predetermined prioritized data replacement and substitution rules substitute data by adding, additions in the updated database ancillary information to the existing user ancillary information 405, to the composite database ancillary information 408, and adding, modifications of the existing user ancillary information 405 in the updated database ancillary information, to the composite database ancillary information 408. After step 505, the method 307 continues to step 507.

At step 507, the system 100 determines for each textual element, if the element's text value in the Oper.xml file 406 has the same value as the element's text vale in the Bench.xml file 405. If the determination at step 507 is positive, then the process continues to step 508. Otherwise, if the determination at step 507 is negative, then the process continues to step 509.

At step 506, the system 100 does nothing because the model object no longer exists. Step 506 represents an object that was in the first model software release 206, but is not in the second model software release 208.

At step 508, the system 100 uses the textual element from the Model.xml file 408. Step 508 represents textual elements that are the same in the first model 206 and user customized 207 software releases. Since the textual elements are the same, the customer did not modify or add the textual elements and the system 100 uses the textual elements that correspond to the user second model software release 208, which is represented by the textual elements in the Model.xml file 408.

At step 509, the system 100 uses the textual element from the Oper.xml file 406. Step 509 represents textual elements that are not the same in the first model 206 and user customized 207 software releases. Since the textual elements are not the same, the system 100 uses the textual elements that correspond to the user customized software release 207, which is represented by the textual elements in the Oper.xml file 406.

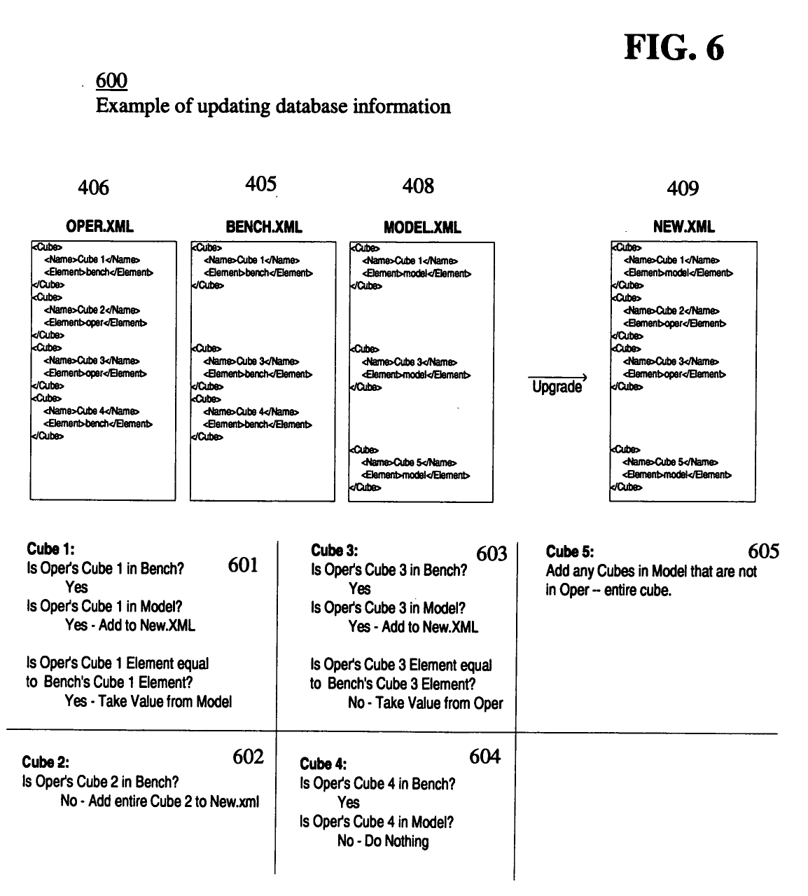

FIG. 6 illustrates an example 600 of updating database information 120 or 122, according to FIGS. 1-5. The example 600 includes the XML files: Oper.xml 406, Bench.xml 405, Model.xml 408, and New.xml 409. The example 600 also includes five comparing and merging processes 601 to 605 corresponding to five cubes 1 to 5.

The existing software release 206 includes a starter set of cubes. Each new software release 208 may add new cubes, remove old cubes, or modify the existing cubes in the existing software release 206. The step of comparing and merging 307, represented by the processes 601 to 605, upgrades the customer's system by: preserving the customer's customizations, upgrading what the customer has not customized so that it looks like the new starter set of cubes, and installing new items that the customer doesn't have already.

In the example 600, the Oper.xml file 406 includes cubes one, two, three, and four. The Bench.xml file 405 includes cubes one, three, and four. The Model.xml file 408 includes cubes one, three, and five. In the example 600, the cubes having the same numbers (e.g., one, two, three, four, and five) have the same information.

Each of the processes 601 to 605 upgrade the customer's system by comparing and merging the Oper.xml file 406, the Bench.xml file 405, and the Model.xml file 408 to produce the New.xml file 409 for each of the five corresponding cubes.

Process 601 determines that because the objects in cube one in the Oper.xml file 406 are in both the Bench.xml file 405 and the Model.xml file 408 (corresponding to steps 502 and 503, respectively, in FIG. 5), the process 601 adds the objects in cube one to the New.xml file 409 (corresponding to step 505 in FIG. 5). Next, process 601 determines that because textual elements in cube one in the Oper.xml file 406 are the same as that in the Bench.xml file 405 (corresponding to step 507 in FIG. 5), the process 601 uses the textual elements from the Model.xml file 408 (corresponding to step 508 in FIG. 5).

Process 602 determines that because the objects in cube two in the Oper.xml file 406 are not in the Bench.xml file 405 (corresponding to step 502 in FIG. 5), process 602 adds the objects in cube two to the New.xml file 409 (corresponding to step 504 in FIG. 5).

Process 603 determines that because the objects in cube three in the Oper.xml file 406 are in both the Bench.xml file 405 and the Model.xml file 408 (corresponding to steps 502 and 503, respectively, in FIG. 5), the process 603 adds the objects in cube three to the New.xml file 409 (corresponding to step 505 in FIG. 5). Next, process 603 determines that because the textual elements in cube three in the Oper.xml file 406 are not the same as that in the Bench.xml file 405 (corresponding to step 507 in FIG. 5), the process 603 uses the textual elements from the Oper.xml file 406 (corresponding to step 509 in FIG. 5).

Process 604 determines that because the objects in cube four in the Oper.xml file 406 are in the Bench.xml file 405, but not in the Model.xml file 408 (corresponding to steps 502 and 503, respectively, in FIG. 5), the process 604 does nothing because the object in cube four no longer exist in the Model.xml file 408 (corresponding to step 506 in FIG. 5).

Process 605 determines that because the objects in cube five are not found in the Oper.xml file 406 or in the Bench.xml file 405, but are found in the Model.xml file 408 (corresponding to steps 502 and 503, respectively, in FIG. 5), the process 605 the adds the objects in cube five that were found in the Model.xml file 408 to the New.xml file 409 (corresponding to step 505 in FIG. 5).

In a particular example, the system 100 and method 300 automates the process of upgrading a software vendor's implementation of an MS-OLAP (i.e., a SQL server analysis services) database, while preserving customer adaptations and additions made to the same MS-OLAP database. The method 300 includes both a MS-OLAP upgrade process and a MS-OLAP compare and merge process. The system 100 and method 300 use an XML structure that describes an MS-OLAP database, extensible stylesheet language transformation (XSLT) (i.e., a language for transforming XML documents into other XML documents), and an MS-OLAP API, to eliminate the error-prone, time consuming manual approach which had been previously used for performing an equivalent upgrade. The result is an efficient, effective system for performing MS-OLAP database upgrades.

For example, the system 100 and method 300 advantageously:
1. Eliminates the need to document the manual upgrade instructions, which accelerates development because less time is spent documenting the upgrade instructions, and removes the tendency for missed or imprecise instructions.
2. Improves the speed and effectiveness of the upgrade process because an automated approach is faster than manually performing upgrade instructions and eliminates the opportunity for missed or incorrectly performed manual instructions.

The system employs, for example, MS-OLAP decision support objects (DSO) API, which is an XML structure that describes an MS-OLAP database (MS-OLAP XML), and XSLT, and meets MS-OLAP database upgrade requirements including: preserving customer adaptations and additions to the MS-OLAP database objects, using existing model MS-OLAP database objects for unchanged upgrades, and installing new model MS-OLAP database objects.

In the described example, a software vendor delivers both an operational and a model MS-OLAP database to the customer. If the software vendor delivers an operational MS-OLAP database without a model MS-OLAP database, the steps involving the existing model MS-OLAP database need to be performed by the software vendor in its development center and delivered as part of the software vendor's installation.

While the present invention has been described with reference to various illustrative embodiments thereof, the present invention is not intended that the invention be limited to these specific embodiments. Those skilled in the art will recognize that variations, modifications, and combinations of the disclosed subject matter can be made without departing from the spirit and scope of the invention as set forth in the appended claims.

What is claimed is:

1. A method for updating database information, comprising the activities of:
converting existing user ancillary information supporting querying of an existing database of a user to a first format supporting interchange of structured data;
receiving updated database ancillary information supporting querying of said existing database in said first format; and
automatically comparing and merging said existing user ancillary information in said first format and said received updated database ancillary information in said first format to create composite database ancillary information by:
identifying differences between said updated and existing ancillary information, and
applying predetermined prioritized data replacement and substitution rules in merging said updated and existing ancillary information.

2. A method according to claim 1, wherein
said user ancillary information supporting querying of an existing database is online analytical processing (OLAP) compatible information.

3. A method according to claim 1, wherein
said first format supporting interchange of structured data comprises at least one of, (a) XML compatible data format, (b) SGML compatible data format, and (c) HTML compatible data format.

4. A method according to claim 1, wherein
said predetermined prioritized data replacement and substitution rules substitute data by
adding, user generated modifications of said existing user ancillary information, to said composite database ancillary information, and
adding, user generated additions to said existing user ancillary information, to said composite database ancillary information.

5. A method according to claim 4, wherein
said predetermined prioritized data replacement and substitution rules substitute data by
adding, additions in said updated database ancillary information to said existing user ancillary information, to said composite database ancillary information, and
adding, modifications of said existing user ancillary information in said updated database ancillary information, to said composite database ancillary information.

6. A method according to claim 1, including
updating said composite database ancillary information to include data type determination information compatible with user information stored in a database.

7. A method according to claim 6, wherein
said database storing said user information is remote from said composite database ancillary information.

8. A method according to claim 1, further comprising the activity of:
archiving the existing user ancillary information.

9. A method according to claim 1, further comprising the activity of:
renaming the existing user ancillary information.

10. A method according to claim 6, further comprising the activity of:
synchronizing data type and length of physical dimensional model tables with the composite database ancillary information.

11. A method according to claim 1, further comprising the activity of:
converting the updated database ancillary information to said first format supporting interchange of structured data.

12. A method for updating database information, comprising the activities of:
archiving the existing user ancillary information supporting querying of an existing database of a user;
renaming the existing user ancillary information;
converting existing user ancillary information to a first format supporting interchange of structured data;
receiving updated database ancillary information supporting querying of said existing database in said first format;
converting the updated database ancillary information to said first format supporting interchange of structured data;
automatically comparing and merging said existing user ancillary information in said first format and said received updated database ancillary information in said first format to create composite database ancillary information by:
identifying differences between said updated and existing ancillary information, and
applying predetermined prioritized data replacement and substitution rules in merging said updated and existing ancillary information;
updating said composite database ancillary information to include data type determination information compatible with user information stored in a database; and
synchronizing data type and length of physical dimensional model tables with the composite database ancillary information.

13. A method according to claim 12, wherein
said user ancillary information supporting querying of an existing database is online analytical processing (OLAP) compatible information.

14. A method according to claim 12, wherein
said first format supporting interchange of structured data comprises at least one of, (a) XML compatible data format, (b) SGML compatible data format, and (c) HTML compatible data format.

15. A method according to claim 12, wherein
said predetermined prioritized data replacement and substitution rules substitute data by:
adding, user generated modifications of said existing user ancillary information, to said composite database ancillary information, and
adding, user generated additions to said existing user ancillary information, to said composite database ancillary information.

16. A method according to claim 15, wherein
said predetermined prioritized data replacement and substitution rules substitute data by
adding, additions in said updated database ancillary information to said existing user ancillary information, to said composite database ancillary information, and
adding, modifications of said existing user ancillary information in said updated database ancillary information, to said composite database ancillary information.

17. A method for updating database information, comprising the activities of:
receiving first version of an online analytical processing (OLAP) database including a first predetermined set of model dimensions and cubes;
adapting the first version of the OLAP database to produce a custom OLAP database, including the activities of:
modifying the first predetermined set of model dimensions and cubes, and
adding new model dimensions and cubes to the first predetermined set of model dimensions and cubes; and
upgrading the first version of the OLAP database with a second version of the OLAP database, including a second predetermined set of model dimensions and cubes, while preserving the modified model dimensions and cubes and the added new model dimensions and cubes made to the first version of the OLAP database.

18. A method according to claim 17, wherein the first and second versions of the OLAP database is a Microsoft® OLAP database.

19. A method for updating database information, comprising the activities of:
providing a first version of an online analytical processing (OLAP) database including a first predetermined set of model dimensions and cubes;
permitting adaptation of the first version of the OLAP database to produce a custom OLAP database, including the activities of:
permitting modification the first predetermined set of model dimensions and cubes, and
permitting addition of new model dimensions and cubes to the first predetermined set of model dimensions and cubes; and
providing a second version of the OLAP database, including a second predetermined set of model dimensions and cubes, to upgrade the first version of the OLAP database, while preserving the modified model dimensions and cubes and the added new model dimensions and cubes made to the first version of the OLAP database.

20. A method according to claim 19, wherein the first and second versions of the OLAP database is a Microsoft® OLAP database.
